(19) United States
(12) Patent Application Publication
(10) Pub. No.: US 2003/0162879 A1
(43) Pub. Date: Aug. 28, 2003

(54) Preparation of an aqueous polymer dispersion curable thermally

(75) Inventors: Matthias Laubender, Schifferstadt (DE); Matthias Gerst, Neustadt (DE); Bernd Reck, Gruenstadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/366,315

(22) Filed: Feb. 14, 2003

(30) Foreign Application Priority Data
Feb. 27, 2002 (DE) 10208361.4

(51) Int. Cl. C08K 3/20

(52) U.S. Cl. 524/457

(57) ABSTRACT

The present invention relates to a process for preparing an aqueous polymer dispersion comprising dispersed polymer particles of at least one addition polymer A1 obtainable by semicontinuous free-radical emulsion polymerization of ethylenically unsaturated monomers in the presence of an addition polymer A2 synthesized from

from 50 to 99.5% by weight of at least one ethylenically unsaturated monocarboxylic and/or dicarboxylic acid,

from 0.5 to 50% by weight of at least one ethylenically unsaturated compound selected from the esters of ethylenically unsaturated monocarboxylic acids and the monoesters and diesters of ethylenically unsaturated dicarboxylic acids with an amine containing at least one hydroxyl group, and

up to 20% by weight of at least one further monomer,

which comprises supplying

a) at least one portion of the ethylenically unsaturated monomers,

b) a portion of the water,

c) at least one portion of the polymer A2, and, if desired

d) portions or entireties of further auxiliaries

to the polymerization vessel together, without an emulsion being formed, through a feed line.

The present invention relates to a process for preparing an aqueous polymer dispersion comprising dispersed polymer particles of at least one addition polymer Al obtainable by semicontinuous free-radical emulsion polymerization of ethylenically unsaturated monomers in the presence of an addition polymer A2 synthesized from

from 50 to 99.5% by weight of at least one ethylenically unsaturated monocarboxylic and/or dicarboxylic acid,

from 0.5 to 50% by weight of at least one ethylenically unsaturated compound selected from the esters of ethylenically unsaturated monocarboxylic acids and the monoesters and diesters of ethylenically unsaturated dicarboxylic acids with an amine containing at least one hydroxyl group, and

up to 20% by weight of at least one further monomer,

which comprises supplying

a) at least one portion of the ethylenically unsaturated monomers,

b) a portion of the water,

c) at least one portion of the polymer A2, and, if desired

d) portions or entireties of further auxiliaries

to the polymerization vessel together, without an emulsion being formed, through a feed line.

German patent application DE-A 19949592 describes at length the preparation of aqueous, heat-curable polymer dispersions of the abovementioned type. It discloses as advantageous the supplying of polymer A2 together with the monomers forming the polymer A1, in the form of an aqueous emulsion, to the reaction vessel. Likewise described is the supplying of the reaction components to the reaction vessel by way of two or more separate feeds.

Taking consideration of apparatus involved and also measurement and control equipment, supplying the reaction components by way of only one feed is preferential. A problem associated with single-feed supplying of the reaction components in the form of an aqueous emulsion, which is normally prepared either in an upstream reactor or using static and/or dynamic mixing elements in the feed line, is that increasing levels of polymer A2 entail a sharp rise in viscosity of the aqueous emulsion, resulting in long metering times with the pumps and pipelines commonly employed.

It is an object of the present invention to provide a process for preparing aforementioned aqueous, heat-curable polymer dispersions which successfully operates with only one feed for the ethylenically unsaturated monomers, the water, the polymer A2, and, if desired, further auxiliaries and yet allows improved metering times with the pumps and pipelines commonly employed.

We have found that this object is achieved by the process defined at the outset.

In connection with the monomer components of the addition polymer A1, alkyl below stands preferably for straight-chain or branched C₁-C₂₂ alkyl radicals, especially C₁-C₁₂, and, with particular preference, C₁-C₆ alkyl radicals, such as methyl, ethyl, n-propyl, n-butyl, sec-butyl, tert-butyl, n-pentyl, n-hexyl, 2-ethylhexyl, n-dodecyl or n-stearyl.

Hydroxyalkyl stands preferably for hydroxy-C₁-C₆ alkyl, the alkyl radicals being straight-chain or branched, and in particular for 2-hydroxyethyl, 2- or 3-hydroxypropyl, 2-methyl-2-hydroxypropyl, and 4-hydroxybutyl.

Cycloalkyl stands preferably for C₅-C₇ cyclohexyl, especially cyclopentyl and cyclohexyl.

Aryl stands preferably for phenyl or naphthyl.

The polymer A1 is a free-radical emulsion polymer. For its preparation it is possible to use all monomers which can be polymerized by free-radical addition polymerization. Generally, the polymer is synthesized from

from 80 to 100% by weight, preferably from 85 to 99.9% by weight, based on the total weight of the monomers for the polymer, of at least one ethylenically unsaturated principal monomer and also

from 0 to 20% by weight, preferably from 0.1 to 15% by weight, based on the total weight of the monomers for the polymer, of at least one ethylenically unsaturated comonomer.

The principal monomer is preferably selected from

esters of preferably C₃-C₆ α,β-monoethylenically unsaturated monocarboxylic or dicarboxylic acid, such as acrylic acid, methacrylic acid, maleic acid, fumaric acid, and itaconic acid, with C₁-C₁₂, preferably C₁-C₈, alkanols. Particular such esters are methyl, ethyl, n-butyl, isobutyl, tert-butyl, n-pentyl, isopentyl, and 2-ethylhexyl acrylate and/or methacrylate;

vinylaromatic compounds, preferably styrene, α-methylstyrene, o-chlorostyrene, vinyltoluenes, and mixtures thereof;

vinyl esters of C₁-C₁₈ monocarboxylic or dicarboxylic acids, such as vinyl acetate, vinyl propionate, vinyl n-butyrate, vinyl laurate and/or vinyl stearate;

butadiene;

linear 1-olefins, branched-chain 1-olefins or cyclic olefins, such as ethene, propene, butene, isobutene, pentene, cyclopentene, hexene or cyclohexene, for example. Also suitable are oligoolefins prepared with metallocene catalysis and containing a terminal double bond, such as oligopropene or oligohexene, for example;

acrylonitrile, methacrylonitrile;

vinyl and allyl alkyl ethers having from 1 to 40 carbon atoms in the alkyl radical, which alkyl radical may also bear further substituents, such as one or more hydroxyl groups, one or more amino or diamino groups or one or more alkoxylate groups; examples include methyl vinyl ether, ethyl vinyl ether, propyl vinyl ether, and 2-ethylhexyl vinyl ether, isobutyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-n-butylamino)ethyl vinyl ether, methyldiglycol vinyl ether, and the corresponding allyl ethers, or mixtures thereof.

Particularly preferred principal monomers are styrene, methyl methacrylate, n-butyl acrylate, ethyl acrylate, 2-ethylhexyl acrylate, vinyl acetate, ethene, and butadiene. It is of course possible to use mixtures of aforementioned monomers.

The comonomer is preferably selected from

ethylenically unsaturated monocarboxylic or dicarboxylic acids or their anhydrides, preferably acrylic acid, methacrylic acid, methacrylic anhydride, maleic acid, maleic anhydride, fumaric acid and/or itaconic acid;

C₁-C₄ hydroxyalkyl esters of C₃-C₆ monocarboxylic or dicarboxylic acids, especially of acrylic acid, methacrylic acid or maleic acid, or their derivatives alkoxylated with from 2 to 50 mol of ethylene oxide, propylene oxide, butylene oxide or mixtures thereof, or esters of C₁-C₁₈ alcohols alkoxylated with from 2 to 50 mol of ethylene oxide, propylene oxide, butylene oxide or mixtures thereof with the abovementioned acids; examples include hydroxyethyl acrylate, hydroxyethyl methacrylate, hydroxypropyl acrylate, hydroxypropyl methacrylate, butane-1,4-diol monoacrylate, ethyldiglycol acrylate, methylpolyglycol acrylate (11 EO), (meth)acrylic esters of C₁₃/C₁₅ oxo alcohol reacted with 3, 5, 7, 10 or 30 mol of ethylene oxide, or mixtures thereof;

vinylphosphonic acids and their salts, dimethyl vinylphosphonate, and other phosphorus monomers;

alkylaminoalkyl(meth)acrylates or alkylaminoalkyl(meth)acrylamides or their quaternization products, such as 2-(N,N-dimethylamino)ethyl(meth)acrylate or 2-(N,N,N-trimethylammonium)ethyl methacrylate chloride, 3-(N,N-dimethylamino)propyl(meth)acrylate, 2-dimethylaminoethyl(meth)acrylamide, 3-dimethylaminopropyl(meth)acrylamide, 3-trimethylammoniumpropyl(meth)acrylamide chloride, and mixtures thereof;

allyl esters of C₁-C₃₀ monocarboxylic acids;

N-vinyl compounds, such as N-vinylformamide, N-vinyl-N-methylformamide, N-vinylpyrrolidone, N-vinylimidazole, 1-vinyl-2-methyl-imidazole, 1-vinyl-2-methylimidazoline, 2-vinylpyridine, 4-vinylpyridine, N-vinylcarbazole and/or N-vinylcaprolactam;

diallyldimethylammonium chloride, vinylidene chloride, vinyl chloride, acrolein, and methacrolein;

monomers containing 1,3-diketo groups, such as acetoacetoxyethyl(meth)acrylate or diacetone acrylamide, monomers containing urea groups, such as ureidoethyl(meth)acrylate, acrylamidoglycolic acid, methacrylamidoglycolate methyl ether;

monomers containing silyl groups, such as trimethoxysilylpropyl methacrylate;

monomers containing glycidyl groups, such as glycidyl methacrylate.

Particularly preferred comonomers are hydroxyethyl acrylate, hydroxypropyl acrylate, hydroxybutyl acrylate, hydroxyethyl methacrylate, glycidyl monomers, and mixtures thereof. Very particular preference is given to hydroxyethyl acrylate and hydroxyethyl methacrylate, particularly in amounts of from 2 to 20% by weight, based on the total amount of the monomers used to prepare the polymer A1.

The addition polymer A2 contains in incorporated form from 50 to 99.5% by weight, preferably from 70 to 99% by weight, of structural units derived from at least one ethylenically unsaturated monocarboxylic or dicarboxylic acid. Within the polymer, these acids may also be present, if desired, fully or partly in the form of a salt. The acidic form is preferred.

The polymer A2 has a water solubility of preferably more than 10 g/l (at 25° C.).

Useful ethylenically unsaturated carboxylic acids have already been mentioned above in connection with the polymer A1. Preferred carboxylic acids are C₃ to C₁₀ monocarboxylic and C₄ to C₈ dicarboxylic acids, particularly acrylic acid, methacrylic acid, crotonic acid, fumaric acid, maleic acid, 2-methylmaleic acid and/or itaconic acid. Particular preference is given to acrylic acid, methacrylic acid, maleic acid, and mixtures thereof. In the preparation of the polymer A2 it is of course also possible to replace or accompany the acids by their anhydrides, such as maleic anhydride, acrylic or methacrylic anhydride.

The polymer A2 further contains from 0.5 to 50% by weight, preferably from 1 to 30% by weight, of at least one ethylenically unsaturated compound selected from the esters of ethylenically unsaturated monocarboxylic acids and the monoesters and diesters of ethylenically unsaturated dicarboxylic acids with at least one hydroxyl-containing amine, in copolymerized form.

The polymer A2 is preferably in the form of a comb polymer with covalently bonded amine side chains.

Monocarboxylic acids suitable as components of the esters are the aforementioned C₃ to C₁₀ monocarboxylic acids, especially acrylic acid, methacrylic acid, crotonic acid, and mixtures thereof.

Dicarboxylic acids suitable as components of the monoesters and diesters are the aforementioned C₄ to C₈ dicarboxylic acids, especially fumaric acid, maleic acid, 2-methylmaleic acid, itaconic acid, and mixtures thereof.

The amine containing at least one hydroxyl group is preferably selected from secondary and tertiary amines having at least one C₆ to C₂₂ alkyl, C₆ to C₂₂ alkenyl, aryl-C₆ to C₂₂ alkyl or aryl-C₆ to C₂₂ alkenyl radical, the alkenyl group containing 1, 2 or 3 nonadjacent double bonds.

The amine is preferably hydroxyalkylated and/or alkoxylated. Alkoxylated amines contain preferably one or two alkylene oxide radicals with terminal hydroxyl groups. The alkylene oxide radicals each contain preferably from 1 to 100, more preferably from 1 to 50, identical or different alkylene oxide units, randomly distributed or in the form of blocks. Preferred alkylene oxides are ethylene oxide, propylene oxide and/or butylene oxide. Ethylene oxide is particularly preferred.

The polymer A2 preferably contains in incorporated form an unsaturated compound based on an amine component, comprising at least one amine of the formula

R^{c}NR^{a}R^{b}

where

R^{c} is C₆ to C₂₂ alkyl, C₆ to C₂₂ alkenyl, aryl-C₆-C₂₂ alkyl or aryl-C₆-C₂₂ alkenyl, the alkenyl radical containing 1, 2 or 3 nonadjacent double bonds,

R^{a} is hydroxy-C₁-C₆ alkyl or a radical of the formula II

—(CH₂CH₂O)ₓ(CH₂CH(CH₃)O)_{y}—H (II)

where

in the formula II the sequence of the alkylene oxide units is arbitrary and x and y independently of one another are an integer from 0 to 100, preferably from 0 to 50, the sum of x and y being >1,

R^{b} is hydrogen, C₁ to C₂₂ alkyl, hydroxy-C₁-C₆ alkyl, C₆ to C₂₂ alkenyl, aryl-C₆-C₂₂ alkyl, aryl-C₆-C₂₂ alkenyl or C₅ to C₈ cycloalkyl, the alkenyl radical containing 1, 2 or 3 nonadjacent double bonds,

or R^{b} is a radical of the formula III

—(CH₂CH₂O)ᵥ(CH₂CH(CH₃)O)_{w}—H (III)

where

in the formula III the sequence of the alkylene oxide units is arbitrary and v and w independently of one another are an integer of from 0 to 100, preferably from 0 to 50.

R^{c} is preferably C₈ to C₂₀ alkyl or C₈ to C₂₀ alkenyl, the alkenyl radical containing 1, 2 or 3 nonadjacent double bonds. R^{c} is preferentially the hydrocarbon radical of a saturated or mono- or polyunsaturated fatty acid. Examples of preferred radicals R^{c} include n-octyl, ethylhexyl, undecyl, lauryl, tridecyl, myristyl, pentadecyl, palmityl, margaryl, stearyl, palmitoleyl, oleyl and linolyl.

With particular preference the amine component is an alkoxylated fatty amine or an alkoxylated fatty amine mixture. The ethoxylates are particularly preferred. Use is made in particular of alkoxylates of amines based on naturally occurring fatty acids, such as tallow fatty amines, for example, which contain predominantly saturated and unsaturated C₁₄, C₁₆, and C₁₈ alkylamines, or coconut amines, which contain saturated, monounsaturated, and diunsaturated C₆-C₂₂, preferably C₁₂-C₁₄, alkylamines. Amine mixtures suitable for alkoxylation are, for example, various Armeen® grades from Akzo or Noram® grades from Ceca.

Examples of suitable commercially available alkoxylated amines are the Noramox® grades from Ceca, preferably ethoxylated oleylamines, such as Noramox®05 (5 EO units), and the products sold under the brand name Lutensol®FA by BASF AG.

The copolymerization of the aforementioned esters, monoesters, and diesters has the general effect of imparting pronounced stability to the polymer dispersion of the invention. The polymer dispersions of the invention reliably retain the colloidal stability of their latex particles on dilution with water or dilute electrolytes or surfactant solutions.

The esterification in the preparation of the above-described esters, monoesters, and diesters is accomplished by standard methods, known to the skilled worker. To prepare esters of unsaturated monocarboxylic acids it is possible to use the free acids or suitable derivatives, such as anhydrides, halides, e.g., chlorides, and (C₁ to C₄) alkyl esters. The preparation of monoesters of unsaturated dicarboxylic acids is accomplished preferably starting from the corresponding dicarboxylic anhydrides. The reaction takes place preferably in the presence of a catalyst, such as a dialkyl titanate or an acid, such as sulfuric acid, toluenesulfonic acid or methanesulfonic acid. The reaction takes place generally at reaction temperatures from 60 to 200° C. In one suitable embodiment the reaction takes place in the presence of an inert gas, such as nitrogen. Water formed during the reaction can be removed from the reaction mixture by appropriate measures, such as distillative removal. The reaction may take place, where desired, in the presence of customary polymerization inhibitors. The esterification reaction can be carried out to substantial completion or only up to a certain partial conversion. If desired, one of the ester components, preferably the hydroxyl-containing amine, can be used in excess. The extent of esterification can be determined by means of infrared spectroscopy.

In one preferred embodiment, the preparation of the unsaturated esters, monoesters or diesters and their further reaction to give the polymers A2 used in accordance with the invention takes place without isolation of the esters and, preferably, in succession in the same reaction vessel.

For preparing the polymers A2 it is preferred to use a reaction product of a dicarboxylic anhydride, preferably maleic anhydride, and one of the above-described hydroxyl-containing amines.

Besides the carboxylic acid and the ester, monoester and/or diester constituents, the polymer A2 may also contain, in copolymerized form, from 0 to 20% by weight, preferably from 0.1 to 10% by weight, of other monomers. Useful monomers are the monomers mentioned in connection with the polymer A1, particular preference being given to vinylaromatics, such as styrene, olefins, such as ethylene, or (meth)acrylic esters such as methyl(meth)acrylate, ethyl(meth)acrylate, n-butyl(meth)acrylate, 2-ethylhexyl(meth)acrylate, and mixtures thereof.

The polymers A2 are prepared preferably by free-radical polymerization without solvent or in solution. Examples of suitable solvents for solution polymerization are water, water-miscible organic solvents, such as alcohols and ketones, examples being methanol, ethanol, n-propanol, isopropanol, n-butanol, acetone, methyl ethyl ketone etc., and mixtures thereof. Examples of suitable polymerization initiators are peroxides, hydroperoxides, peroxodisulfates, percarbonates, peroxo esters, hydrogen peroxide, and azo compounds, as described in more detail below for the preparation of the polymer dispersions of the invention.

The polymers A2 may also be prepared advantageously by polymer-analogous reaction. For this an addition polymer containing in incorporated form from 80 to 100% by weight of at least one ethylenically unsaturated monocarboxylic and/or dicarboxylic acid and from 0 to 20% by weight of the abovementioned other polymers can be reacted with at least one hydroxyl-containing amine.

Suitable ethylenically unsaturated monocarboxylic and dicarboxylic acids are those specified above as components of the polymers A1 and A2. Suitable amines containing at least one hydroxyl group are again those specified above. Within the addition polymer used for the polymer-analogous reaction, the acids may if desired be present wholly or partly in the form of a derivative, preferably a C₁ to C₆ alkyl ester.

Preparation of the polymers A2 by polymer-analogous reaction takes place preferably in a suitable nonaqueous solvent or without solvent. In the case of reaction without solvent, the amine component may where appropriate be used in excess so as to act as a solvent. Preferred solvents are those which form an azeotrope with water and so allow easy removal of the water formed during the reaction. The reaction takes place preferably in the presence of an esterification catalyst, as described above. The reaction temperature lies preferably within a range from 100 to 200° C. Water formed during the reaction may be removed by appropriate measures, such as distillative removal.

The process of the invention more particularly comprises introducing a portion, frequently ≦50% by weight or ≦40% by weight and often ≦30% by weight or ≦20% by weight, of the total amount of water used into the polymerization vessel prior to the polymerization, and, after the free-radical polymerization has been initiated, supplying

a) at least one portion of the ethylenically unsaturated monomers,

b) a portion of the water,

c) at least one portion of the polymer A2, and, if desired,

d) portions or entireties of further auxiliaries

to the polymerization vessel together, without an emulsion being formed, through a feed line.

In the novel process it is possible to include a portion of the ethylenically unsaturated monomers, where appropriate in the presence of a suitable seed latex, in the initial charge to the polymerization vessel. The amount of monomer charged initially to the reaction vessel may be ≦50% by weight, ≦20% by weight or ≦10% by weight, based in each case on the total monomer amount. It is, however, preferred to supply ≧50% by weight, ≧70% by weight, ≧90% by weight, and, frequently, the entirety of the ethylenically unsaturated monomers to the polymerization vessel through the feed line under polymerization conditions.

The amount of water supplied through the feed line during the polymerization is customarily ≧50% by weight, ≧60% by weight or ≧70% by weight, based in each case on the total amount of water. In the whole process it is preferred to use deionized water.

At least a portion of the polymer A2 is supplied through the feed line during the polymerization, frequently ≧50% by weight, ≧70% by weight, ≧90% by weight, or even the total amount of polymer A2 (solids). It is of course also possible to include a polymer A2 portion, often ≦50% by weight, ≦20% by weight or ≦10% by weight, based in each case on the total amount of the polymer A2 (solids), in the initial charge to the polymerization vessel before the beginning of the polymerization. Polymer A2 is frequently used in the form of an aqueous solution.

It is advantageous to supply ≧50% by weight, frequently ≧60% by weight, and often ≧70% by weight of the total amount of ethylenically unsaturated monomers used to prepare the polymer A1 and ≧50% by weight, frequently ≧60% by weight, and often ≧70% by weight of the polymer A2 (solids) together to the polymerization vessel through the feed line under polymerization conditions.

The weight ratio of polymer A2 (solids) to the total amount of the ethylenically unsaturated monomers used to prepare the polymer A1 is preferably in the range from 7:1 to 1:7, in particular from 3:1 to 1:3.

It is significant that the polymerization may be conducted in the presence of auxiliaries, such as at least one surface-active alkoxylated alkylamine, a hydroxyl-containing crosslinker and/or a reaction accelerator, for example. These auxiliaries, and the amounts for their optional use, are described at length in German patent application DE-A 19949592 on page 6 line 45 to page 8 line 10 and are to be taken as included in the subject matter of the present invention. The entirety of the auxiliaries may be included in the initial charge to the polymerization vessel before polymerization. It is, however, also possible, where appropriate, to include one portion in the initial charge to the polymerization vessel and to supply the remainder or the entirety of the auxiliaries to the polymerization vessel through the feed line during the polymerization. It is preferred to add at least a portion of the optional auxiliaries through the feed line during the polymerization.

For the process of the invention it is preferred to use in all

from 50 to 70 parts by weight of ethylenically unsaturated monomers,

from 30 to 50 parts by weight of polymer A2 (solids), and, if desired,

from 0 to 10 parts by weight of surface-active alkoxylated alkylamine,

from 0 to 20 parts by weight of hydroxyl-containing crosslinker, and/or

from 0 to 5 parts by weight of reaction accelerator for the polymerization.

The polymer dispersion is generally prepared in water as dispersing medium. It is, however, also possible for water-miscible organic solvents to be present, such as alcohols and ketones, examples being methanol, ethanol, n-propanol, isopropanol, n-butanol, acetone and methyl ethyl ketone, in a fraction of up to about 30% by volume.

The polymerization is conducted in the presence of compounds which form free radicals (initiators). The amount required of these compounds is preferably from 0.05 to 10% by weight, with particular preference from 0.2 to 5% by weight, based on the monomers used in the polymerization.

Examples of suitable polymerization initiators are peroxides, hydroperoxides, peroxodisulfates, percarbonates, peroxo esters, hydrogen peroxide, and azo compounds. Examples of initiators, which may be soluble in water or else insoluble in water, are hydrogen peroxide, dibenzoyl peroxide, dicyclohexyl peroxodicarbonate, dilauroyl peroxide, methyl ethyl ketone peroxide, di-tert-butyl peroxide, acetylacetone peroxide, tert-butyl hydroperoxide, cumene hydroperoxide, tert-butyl perneodecanoate, tert-amyl perpivalate, tert-butyl perpivalate, tert-butyl perneohexanoate, tert-butyl per-2-ethylhexanoate, tert-butyl perbenzoate, lithium, sodium, potassium and ammonium peroxodisulfate, azodiisobutyronitrile, 2,2′-azobis(2-amidinopropane) dihydrochloride, 2-(carbamoylazo)isobutyronitrile, and 4,4′-azobis(4-cyanovaleric acid). The known redox initiator systems as well, such as H₂O₂/ascorbic acid or t-butyl hydroperoxide/sodium hydroxymethanesulfinate, for example, can be used as polymerization initiators.

The initiators may be employed alone or in mixtures with one another, examples being mixtures of hydrogen peroxide and sodium peroxodisulfate. For polymerization in aqueous medium it is preferred to use water-soluble initiators.

The entirety of the initiators may be included in the initial charge to the polymerization vessel. It is, however, also possible where appropriate to include only a portion of the initiators in the initial charge to the polymerization vessel and to supply any remainder or the entirety of the initiators to the reaction mixture, frequently in the form of an aqueous solution and/or together with the mixture of components a) to d), at polymerization temperature.

Suitable reaction temperatures for the free-radical aqueous emulsion polymerization, depending on the polymerization initiators used, span the entire range from 0 to 170° C. The temperatures used are generally from 50 to 120° C., frequently from 60 to 110° C., and often ≧70 to 100° C. The free-radical aqueous emulsion polymerization may be conducted at a pressure less than, equal to or greater than 1 bar (absolute). It is advantageous to conduct the free-radical aqueous emulsion polymerization under inert gas atmosphere, such as under nitrogen or argon, for example.

To prepare polymers with a low average molecular weight it is often appropriate to conduct the copolymerization in the presence of regulators. For this purpose it is possible to use customary regulators, such as organic compounds containing SH groups, for example, such as 2-mercaptoethanol, 2-mercaptopropanol, mercaptoacetic acid, tert-butyl mercaptan, n-octyl mercaptan, n-dodecyl mercaptan, and tert-dodecyl mercaptan, hydroxylammonium salts such as hydroxylammonium sulfate, formic acid, sodium bisulfite or isopropanol. The polymerization regulators are frequently used in amounts of from 0.05 to 5% by weight, based on the monomers.

The possible further treatment of the aqueous, heat-curable polymer dispersions obtained by the process of the invention, and their use, are described at length in DE-A 19949592.

Through the novel process it is possible to prepare the abovementioned aqueous, heat-curable polymer dispersions in the customary plant-scale polymerization reactors with short cycle times. It is particularly advantageous that no apparatus is needed to preemulsify the monomers, the water, and the polymer A2 and any further auxiliaries, and that, owing to the much lower viscosity, the constituents can be supplied using the standard pumps and feed lines.

The following nonlimiting examples illustrate the invention.

Analysis

The solids contents were determined by drying an aliquot to constant weight in a drying oven at 140° C. Two separate measurements were carried out in each case. The figure reported in the respective examples represents the average of the two results.

The viscosity of the feed mixtures/emulsions was determined in a Brookfield viscometer at a shear rate of 50 s⁻¹ at 23° C. in accordance with ISO 1652.

The quantity of coagulum was determined by filtering the aqueous polymer dispersion, cooled to 20-25° C. (room temperature), through a sieve with a mesh size of 125 μm. For the purpose of the determination the sieve was weighed prior to filtration. After filtration it was flushed with a small amount of deionized water and then dried to constant weight in a drying oven at 100° C. under atmospheric pressure. Upon cooling to room temperature, the sieve was weighed again. The amount of coagulum was given by the difference between the two weighings, based in each case on the amount of aqueous polymer dispersion filtered.

The viscosity of the polymer dispersions was determined in a Rheomat from Physica at a shear rate of 250 s⁻¹ at 23° C. in accordance with DIN 53019.

### EXAMPLES

Working in analogy to Example 1a of DE-A 19949592, an aqueous solution of a carboxyl-containing addition polymer A2 having a solids content of 43% by weight was prepared.

This polymer A2 solution was admixed at 23° C. with monomers and water and was converted, by stirring with a laboratory blade stirrer, into a homogeneous mixture (stirring speed: 20 revolutions per minute; stirring time: 10 seconds), which was stable for about 15 to 30 minutes. More vigorous stirring (stirring speed: 500 revolutions per minute; stirring time: 60 seconds) of mixtures of the same composition gave emulsions which were stable for several weeks. Immediately after the preparation of the mixtures and, respectively, the emulsions, their viscosities were measured. The amounts of polymer A2 solution, monomers, and water used to prepare the various mixtures and emulsions, and the resulting viscosities of the mixtures and emulsions, are listed in Table 1.

TABLE 1
Viscosities of monomer mixtures (M) and monomer
emulsions (E) containing polymer A2

| | Polymer A2 | | | |
|---|---|---|---|---|
| | solution | Monomers | Water | Viscosity |
| | [g] | [g] | [g] | [mPas] |
| M1 | 463 | 145 styrene | 64 | 397 |
| | | 55 methyl methacrylate | | |
| E1 | 463 | 145 styrene | 64 | 1690 |
| | | 55 methyl methacrylate | | |
| M2 | 347 | 145 styrene | 89 | 443 |
| | | 55 methyl methacrylate | | |
| E2 | 347 | 145 styrene | 89 | 956 |
| | | 55 methyl methacrylate | | |

Preparation of Polymer Dispersions 1 to 4

For each preparation a heatable and coolable 2 1 glass reactor, fitted with an anchor stirrer, a reflux condenser, and evacuating and metering means, was charged at room temperature and under nitrogen with 140 g of deionized water and 10% by weight of a feed stream 2, and this initial charge was heated to 85° C. with stirring (120 revolutions per minute). When it reached that temperature, the above-described monomer emulsions E1 and E2 were metered in over the course of 3.5 hours and the above-described amounts of the components of monomer mixture M1 and M2 over the course of one hour, as feed stream 1, through a feed line into the reaction mixture. In parallel with each feed stream 1, the remainder of feed stream 2 was added through a separate feed line. After the end of feed streams 1 and 2 the reaction mixtures were polymerized for a further 30 minutes at reaction temperature, still with stirring, and then cooled to room temperature. The viscosities, solids contents, and coagulum contents of the aqueous polymer dispersions obtained in this way are collated in Table 2.

Feed Stream 1:

Components and amounts of the monomer mixtures M1 and M2 used and also monomer emulsions E1 and E2 as per Table 1.

Feed Stream 2:

62 g of deionized water

2.0 g of sodium peroxodisulfate

TABLE 2
Viscosities, solids contents (SC), and coagulum
contents of the polymer dispersions obtained in
dependence on the mode of addition of the monomers

| Polymer dispersion | Feed | Viscosity | SC | Coagulum content |
|---|---|---|---|---|
| no. | stream 1 | [mPas] | [%] | [%] |
| 1 | M1 | 643 | 50.2 | 0.003 |
| 2 | E1 | 885 | 50.1 | 0.001 |
| 3 | M2 | 737 | 49.7 | 0.001 |
| 4 | E2 | 1150 | 49.9 | 0.004 |

As apparent from Table 2, the polymer dispersions obtained from the monomer mixtures M1 and M2 as well, in comparison to the polymer dispersions obtained from the monomer emulsions E1 and E2, combine a reduced viscosity with otherwise identical product properties.

We claim:

1. A process for preparing an aqueous polymer dispersion comprising dispersed polymer particles of at least one addition polymer A1 obtainable by semicontinuous free-radical emulsion polymerization of ethylenically unsaturated monomers in the presence of an addition polymer A2 synthesized from
from 50 to 99.5% by weight of at least one ethylenically unsaturated monocarboxylic and/or dicarboxylic acid,
from 0.5 to 50% by weight of at least one ethylenically unsaturated compound selected from the esters of ethylenically unsaturated monocarboxylic acids and the monoesters and diesters of ethylenically unsaturated dicarboxylic acids with an amine containing at least one hydroxyl group, and
up to 20% by weight of at least one further monomer,
which comprises supplying
a) at least one portion of the ethylenically unsaturated monomers,
b) a portion of the water,
c) at least one portion of the polymer A2, and, if desired,
d) portions or entireties of further auxiliaries
to the polymerization vessel together, without an emulsion being formed, through a feed line.

2. A process as claimed in claim 1, wherein at least 50% by weight of the ethylenically unsaturated monomers and at least 50% by weight of the polymer A2 are supplied to the reaction vessel together.

3. A process as claimed in either of claims 1 and 2, wherein said further auxiliaries comprise at least one surface-active alkoxylated alkylamine, a hydroxyl-containing crosslinker and/or a reaction accelerator.

4. A process as claimed in claim 3, wherein the polymerization is conducted using
from 50 to 70 parts by weight of ethylenically unsaturated monomers,
from 30 to 50 parts by weight of polymer A2, and, if desired,
from 0 to 10 parts by weight of surface-active alkoxylated alkylamine,
from 0 to 20 parts by weight of hydroxyl-containing crosslinker, and/or
from 0 to 5 parts by weight of reaction accelerator.
